(19) United States
(12) Patent Application Publication
(10) Pub. No.: US 2006/0097229 A1
(43) Pub. Date: May 11, 2006

(54) White rust corrosion inhibitors

(76) Inventors: Jason Mark Grech, Worcester (GB); Christopher Raymond Jones, South Staffordshire (GB)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/533,917

(22) PCT Filed: Nov. 6, 2003
(86) PCT No.: PCT/GB03/04796

§ 371 Date: Oct. 11, 2005

(30) Foreign Application Priority Data
Nov. 8, 2002 (GB) 0226101.4

(51) Int. Cl. C09K 15/00

(52) U.S. Cl. 252/397

(57) ABSTRACT

A corrosion inhibitor for use in a aqueous system is provided. In particular, the invention especially relates to a compound for use as a white rust corrosion inhibitor and to a composition including such a compound. The white rust corrosion inhibiting compound consists of an organo phosphonate having the general formula (I).

This invention relates to corrosion inhibitors and in particular to corrosion inhibitors for use in systems where water is used. The present invention especially relates to a compound for use as a white rust corrosion inhibitor and to a composition including such a compound.

Many of the components of water using systems are made of steel, which has been galvanised with zinc or cadmium by various processes, including hot dip. This is done in order to minimise corrosion of the steel. Zinc is the most commonly used metal for galvanising steel.

The zinc plating protects the steel from corrosion. However, the zinc plating reacts with the atmosphere and with water to produce “white rust” which comprises a variety of zinc compounds including, zinc oxide, zinc carbonates and the like. Under these corrosive conditions the zinc coating may not be able to protect the base steel and thus corrosion of the steel may occur reducing the life expectancy of the system. White rust is therefore problematic in water using industries utilising galvanised steel systems. This has been recognised in the industry (as is shown, for example in “White Rust: An Industry update and Guide Paper” published by the Association of Water Technologies, 2002). However, current philosophy in the industry is to concentrate on the treatment and removal of white rust after it has formed, and/or on its avoidance by selecting construction materials which are not susceptible to its formation.

Hitherto, no corrosion inhibitor currently used in water using systems has been found which is able to inhibit effectively the formation of “white rust”.

It is an object of the present invention to provide a compound and a composition, each of which is effective for inhibiting “white rust” formation and for ameliorating the problem of corrosion caused by “white rust” in systems that have been galvanised with relatively electropositive metals such as zinc or cadmium, especially with zinc.

The applicant has found that the addition, to water using systems, of certain phosphonated oligomers or of random copolymers of vinylidene diphosphonic acid and vinyl sulphonic acid, or of compositions including such compounds, achieves the aforementioned object.

Accordingly, the present invention provides in a first aspect a compound for use as, or in connection with, a white rust corrosion inhibitor for water-treatment, said compound consisting of an organophosphonate having the general formula (I): 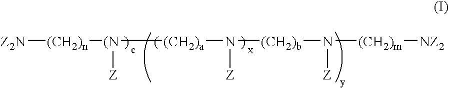
Wherein
Z=—CHR₁PO₃R₂
R=H, CH₃, C₂H₅ or M
R¹=H, CH₃, CR₃, C₆H₅, or SO₃H₂
M=alkali metal or ammonium ion
n=0 to 10
m=0 to 10
a=0 to 10
b=0to 10
c=0 or 1
x=0 to 10
y=0 to 10

In a particularly preferred embodiment of the present invention R and R¹ each =H, n=6, m=6, c=1, y=0 whereby the compound is bis(hexamethylene)triamine-pentakis (methylene phosphonic acid), as in formula (II):

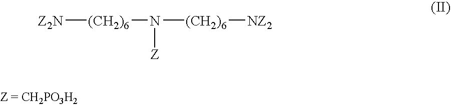

In a second aspect, the present invention provides a compound for use as a white rust corrosion inhibitor for water-treatment, said compound being a random copolymer of vinylidene diphosphonic acid and vinyl sulphonic acid in a molar ratio of between 1:1 and 1:500, suitably about 1:100 molar and preferably about 1:20 molar.

In a third aspect the present invention provides a composition for use as, or in connection with a corrosion inhibitor for water-treatment, said composition comprising a phosphonated oligomer according to the first aspect or a random copolymer of vinylidene diphosphonic acid and vinyl sulphonic acid, according to the second aspect, together with additives conventionally used in the water treatment industry. The additives may include scale inhibitors such as phosphonates, corrosion inhibitors such as phosphonocarboxylic acids or salts and/or dispersants such as polyacrylates. The composition may optionally incorporate a biocide.

In a fourth aspect, the present invention provides a method for inhibiting corrosion in, or in connection with, a water-using system, said method consisting of the application or addition to said system of an effective amount of a phosphonated oligomer according to the first aspect or a random copolymer of vinylidene diphosphonic acid and vinyl sulphonic acid according to the second aspect or of a composition according to the third aspect.

In a preferred embodiment the method according to the fourth aspect consists of the application to a metal prior to contact with water of an effective amount of a phosphonated oligomer according to the first aspect or a random copolymer of vinylidene diphosphonic acid and vinyl sulphonic acid according to the second aspect or of a composition according to the third aspect.

Preferably, in the method according to the fourth aspect of the present invention, the oligomer or co-polymer or composition is used in an effective amount of up to 1000 ppm suitably up to 250 ppm, for example up to 100 ppm

The phosphonocarboxylic acid or salt is preferably a phosphonated oligomer of maleic acid, of general formula (III):
H[CHCO₂MCHCO₂M]ₙPO₃M₂ (III)
wherein M is a cation such that the oligomer is soluble in water, and n is greater than 1. Such phosphonated oligomer's are disclosed in the applicant's EP-B-0491391 and equivalent publications and are available from the applicant as BRICORR® 288.

The polyacrylate compound is preferably a low molecular weight (MW) polymer, e.g. MW=2000-5000. However, it is to be understood that other molecular weight ranges can be used.

The present invention will now be illustrated, merely by way of example, as follows.

Methodology

Test Water

Two test waters were used in the Examples herein below. The relevant properties of the test waters are shown in Table 1 (below).

TABLE I

| | Water 1 | Water 2 |
|---|---|---|
| | (Soft) | (Hard) |
| Calcium Hardness | 0 | 340 |
| (ppm as CaCO₃) | | |
| Alkalinity (ppm as | 500 | 300 |
| CaCO₃) | | |
| Chloride ion (ppm) | 150 | 50 |
| PH | 9 | 9 |

The waters shown in TABLE 1 (above) are known to be corrosive to galvanised steel.

Test Method

The corrosion testing was carried out on a Rotating Coupon Rig. Each Rig holds 2 coupons. The test water was aerated and the galvanised steel coupons (50×25 mm) rotated at 150-160 rpm. Water losses due to evaporation were replaced with de-ionised water daily.

All inhibitors used in the Examples (below) were weighed out on an analytical balance and added directly to the test water. The (pre-weighed) galvanised steel coupons were then rotated for 7 days at 40° C., cleaned to remove any corrosion deposits with warm (70-80° C.) ammonium acetate solution and then rinsed with water and acetone. The galvanised steel coupons were then oven dried and re-weighed.

### EXAMPLES A TO E

The corrosion-inhibiting properties of six compounds or compositions according to the present invention were assessed by subjecting galvanised steel coupons to the test method described herein above. Also included for comparison are results from tests using phosphonates that are conventionally used as steel corrosion inhibitors (examples G, H and I). The result are shown in TABLE II (below):

TABLE II

| | | 0 Ca²⁺ Water | 340 Ca²⁺ Water |
|---|---|---|---|
| | Inhibitor | (Soft) | (Hard) |
| Inhibitor used | Level | Corrosion Rate | Corrosion Rate |
| (see notes below) | (ppm) | (% of control) | (% of Control) |
| Control | 0 | 100 | 100 |
| Example (A) | 100 | 20 | 59.2 |
| Example (B) | 100 | 12 | 89.2 |
| Example (C) | 100 | 15 | 93.3 |
| Example (D) | 100 | 14 | 115 |
| Example (E) | 100 | 20 | 44.2 |
| Example (F) | 100 | — | 51 |
| Example (G) | 100 | 196 | 131 |
| Example (H) | 100 | 112 | — |
| Example (I) | 100 | 82 | — |

Notes to TABLE II
(A) a (random copolymer of Vinylidene Diphosphonic Acid (VDPA) and Vinyl Sulphonic Acid (VSA) in a 1:20 molar ratio) available from the applicant as ITC 1028;
(B) a 23% w/w neutral solution of the potassium salt of hexamethylene diamine tetrakis(methylenephosphonic acid), available from the applicant as BRIQUEST ® 462;
(C) a 25% w/w, neutral, aqueous solution of a sodium salt of pentaethylenehexamine-octakis (methylenephosphonic acid), available from the applicant as BRIQUEST ® 8106-25S;
(D) a 30% w/w aqueous solution of a sodium salt of N, N-bis (3-aminopropyl)amine-hexakis (methylenephosphonic acid), available from the applicant as BRIQUEST ® 684-30S;
(E) a 40% w/w aqueous solution of bis(hexamethylene)triamine pentakis(methylenephosphonic acid), available from the applicant as BRIQUEST ® 5123-45A.
(F) a mixture of BRIQUEST ® 5123-45A with 100 ppm of a formulation containing water treatment polymers and a phosphonated oligomer of maleic acid, available from the applicant as BRICORR ® 288C.
(G) BRICORR ® 288C on its own.
(H) a 60% w/w aqueous solution of 1-hydroxyethane-1,1-diphosphonic acid available from the applicant as BRIQUEST ® ADPA-60A
(I) a 50% w/w aqueous solution of Nitrilotris(methylenephosphonic acid) available from the applicant as BRIQUEST ® 301-50A

It will be apparent from table I that inhibitor (E) gives the best all-round performance.

1-16. (canceled)

17. A method for inhibiting corrosion in, or in connection with, a water-using system, said method consisting of the application or addition to said system of an effective amount of a random copolymer of vinylidene diphosphonic acid and vinyl sulphonic acid in a molar ratio of 1:1 to 1:500 or a phosphonated oligomer having the formula (I): 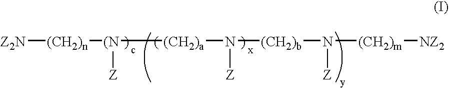
wherein
Z=—CHR₁PO₃R₂
R=H, CH₃, C₂H₅, or M
R¹=H, CH₃, CR₃, C₆H₅, or SO₃H₂
M=alkali metal or ammonium ion
n=0 to 10
m=0 to 10
a=0 to 10
b=0 to 10
c=0 or 1
x=0 to 10
y=0 to 10

18. A method as claimed in claim 17 in which the method consists of the application to a metal prior to contact with water of an effective amount of said phosphonated oligomer or of said random copolymer of vinylidene diphosphonic acid and vinyl sulphonic acid.

19. A compound as claimed in claim 17, in which R and R¹ each =H, n=6, m=6, c=1, y=0 whereby the compound is bis(hexamethylene)triamine-pentakis (methylene phosphoric acid), as in formula (II):

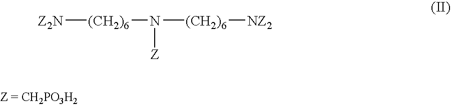

20. A method as claimed in claim 18, in which the oligomer or copolymer is used in an effective amount of up to 1000 ppm.

21. A method as claimed in claim 18, in which the oligomer or copolymer is used in an effective amount of up 250 ppm.

22. A method as claimed in claim 18, in which the oligomer or copolymer is used in an effective amount of up to 100 ppm.

23. A method as claimed in claim 17, in which the oligomer or copolymer is used in an effective amount of up to 1000 ppm.

24. A method as claimed in claim 17, in which the oligomer or copolymer is used in an effective amount of up 250 ppm.

25. A method as claimed in claim 17, in which the oligomer or copolymer is used in an effective amount of up to 100 ppm.
